(19) United States
(12) Patent Application Publication
(10) Pub. No.: US 2008/0220824 A1
(43) Pub. Date: Sep. 11, 2008

(54) Terminal device and incoming e-mail/call notification method

(75) Inventors: Yoshio Miyoshi, Kawasaki (JP); Katsuaki Akama, Kawasaki (JP)

Correspondence Address: HANIFY & KING PROFESSIONAL CORPORATION, 1875 K STREET, NW, SUITE 707, WASHINGTON, DC, 20006, US

(73) Assignee: FUJITSU LIMITED

(21) Appl. No.: 12/010,471

(22) Filed: Jan. 25, 2008

(30) Foreign Application Priority Data
Mar. 9, 2007 (JP) 2007-059333

(51) Int. Cl. H04M 1/00; H04B 1/38

(52) U.S. Cl. 455/567; 455/414.1; 340/540

(57) ABSTRACT

An incoming mail notification unit notifies the user, of the terminal device, of the incoming e-mail when the incoming e-mail is received. A vibration number measurement unit measures the number of vibrations applied to the terminal device. A determination unit determines whether the user has switched from a walking state to a walking-stopped state based on the measured number of vibrations. The incoming mail notification unit re-notifies the user of the incoming e-mail when the determination unit determines that the user has switched from the walking state to the walking-stopped state.

### CROSS-REFERENCE TO RELATED APPLICATIONS

This application claims the conventional priority based on Japanese Application No. 2007-059333, filed on Mar. 9, 2007, the disclosures of which are incorporated herein by reference.

### BACKGROUND OF THE INVENTION

1. Field of the Invention

The present invention relates to a terminal device and an incoming e-mail/call notification method, and more particularly, to a terminal device and an e-mail/call notification method for re-notifying a user of incoming e-mail when the user stops walking if the user of the terminal device such as a cellular phone does not notice the incoming e-mail while walking.

2. Description of the Related Art

When incoming e-mail (incoming mail) arrives, a conventional terminal device such as a cellular phone notifies the user of the incoming e-mail by sounds or vibrations of the cellular phone.

An example of a specific technique relating to the conventional cellular phone described in the Japanese Patent Laid-Open No. 2003-298690 measures the number of steps taken by the cellular phone user, determines whether the user is walking based on the measurement result, and disables the cellular phone when the user is determined to be walking.

Conventionally, even if a terminal device receives incoming e-mail or an incoming call (reception of a call) while the user of the terminal device, such as a cellular phone, is walking, the user may not notice the sounds or vibrations for notifying the user of the incoming e-mail or the incoming call when receiving the e-mail or the call. Conventionally, a technique does not exist which re-notifies the user of the incoming e-mail or the incoming call when the user who is walking stops walking, so that the user is not able to know the incoming e-mail or the incoming call at an early point.

Additionally, the user does not notice the incoming e-mail or the incoming call when the e-mail or the call has arrived while recharging the terminal device, for example.

### SUMMARY OF THE INVENTION

It is an object of the present invention to provide a terminal device that re-notifies a user of incoming e-mail when the user of the terminal device who is walking stops walking.

It is another object of the present invention to provide an incoming e-mail/call notification method for notifying a user of the incoming e-mail when the user of a terminal device who is walking stops walking.

The terminal device of the present invention comprises a mail reception unit for receiving incoming e-mail to the terminal device, an incoming mail notification unit for notifying a user, of the terminal device, of the incoming e-mail when the incoming e-mail is received, a vibration number measurement unit for measuring the number of vibrations applied to the terminal device, and a determination unit for determining whether the user has switched from a walking state to a walking-stopped state based on the number of vibrations measured by the vibration number measurement unit. The incoming mail notification unit re-notifies the user of the incoming e-mail when the determination unit determines that the user has switched from the walking state to the walking-stopped state.

Preferably, the determination unit determines whether the terminal device has switched from a stopped state to a moving state based on the number of vibrations measured by the vibration number measurement unit, and the incoming mail notification unit re-notifies the user of the incoming e-mail when the determination unit determines that the terminal device has switched from the stopped state to the moving state.

Preferably, the terminal device further comprises a call reception unit for receiving an incoming call to the terminal device, and an incoming call notification unit for notifying the user of the incoming call when the call reception unit receives the incoming call. The incoming call notification unit re-notifies the user of the incoming call when the determination unit determines that the user has switched from the walking state to the walking-stopped state.

Preferably, the determination unit determines whether the terminal device has switched from a stopped state to a moving state based on the number of vibrations measured by the vibration number measurement unit. The incoming call notification unit re-notifies the user of the incoming call when the determination unit determines that the terminal device has switched from the stopped state to the moving state.

The incoming e-mail/call notification method of the present invention is the incoming e-mail/call notification method in a terminal device. The incoming e-mail/call notification method comprises receiving incoming e-mail to the terminal device, notifying a user, of the terminal device, of the incoming e-mail when the incoming e-mail is received, measuring the number of vibrations applied to the terminal device, determining whether the user has switched from a walking state to a walking-stopped state based on the measured number of vibrations, and re-notifying the user of the incoming e-mail when the user is determined to have been switched from the walking state to the walking-stopped state.

Preferably, the incoming e-mail/call notification method further comprises determining whether the terminal device has switched from a stopped state to a moving state based on the measured number of vibrations, and re-notifying the user of the incoming e-mail when the terminal device is determined to have been switched from the stopped state to the moving state.

Preferably, the incoming e-mail/call notification method further comprises receiving an incoming call to the terminal device, notifying the user of the incoming call when the incoming call is received, and re-notifying the user of the incoming call when the user is determined to have been switched from the walking state to the walking-stopped state.

Preferably, the incoming e-mail/call notification method further comprises determining whether the terminal device has switched from the stopped state to the moving state based on the measured number of vibrations, and re-notifying the user of the incoming call when the terminal device is determined to have been switched from the stopped state to the moving state.

The terminal device and the incoming e-mail/call notification method of the present invention determine whether the user of the terminal device has switched from the walking state to the walking-stopped state based on the measurement result of the number of vibrations applied to the terminal device, and then re-notify the user of the incoming e-mail based on the determination result. Therefore, according to the present invention, a user, who did not notice the incoming e-mail while walking, is able to confirm the incoming mail when the user stops walking.

Additionally, the terminal device and the incoming e-mail/call notification method of the present invention determine whether the terminal device has switched from the stopped state to the moving state based on the measurement result of the number of vibrations applied to the terminal device, and then re-notify the user of the incoming e-mail based on the determination result. Therefore, according to the present invention, for example, a user, who did not notice the incoming mail when the terminal device was left untouched such as during recharging, is able to confirm the incoming mail when the user grabs the terminal device and is about to move.

The terminal device and the incoming e-mail/call notification method of the present invention determine whether the user of the terminal device has switched from the walking state to the walking-stopped state based on the measurement result of the number of vibrations applied to the terminal device, and then re-notify the user of the incoming call based on the determination result. Therefore, according to the present invention, a user, who did not notice the incoming call while walking, is able to confirm the incoming call when the user stops walking.

Additionally, the terminal device and the incoming e-mail/call notification method of the present invention determine whether the terminal device has switched from the stopped state to the moving state based on the measurement result of the number of vibrations applied to the terminal device, and then re-notify the user of the incoming call based on the determination result. Therefore, according to the present invention, for example, a user, who did not notice the incoming call when the terminal device was left untouched such as during recharging, is able to confirm the incoming call when the user grabs the terminal device and is about to move.

### BRIEF DESCRIPTION OF THE DRAWINGS

FIG. 1 is a diagram showing an example of a structure of a terminal device of the present invention.

FIG. 2 is a diagram showing an example of incoming mail data stored in an incoming mail data storage unit.

FIG. 3 is a diagram showing an example of incoming call data stored in an incoming call data storage unit.

FIG. 4 is a diagram showing an example of an incoming mail notification processing flow of the terminal device of the present invention.

FIG. 5 is an example of a screen for notifying incoming e-mail.

FIG. 6 is a diagram showing an incoming call notification processing flow of the terminal device of the present invention.

FIG. 7 is an example of a screen for notifying an incoming call.

### DETAILED DESCRIPTION OF THE PREFERRED EMBODIMENTS

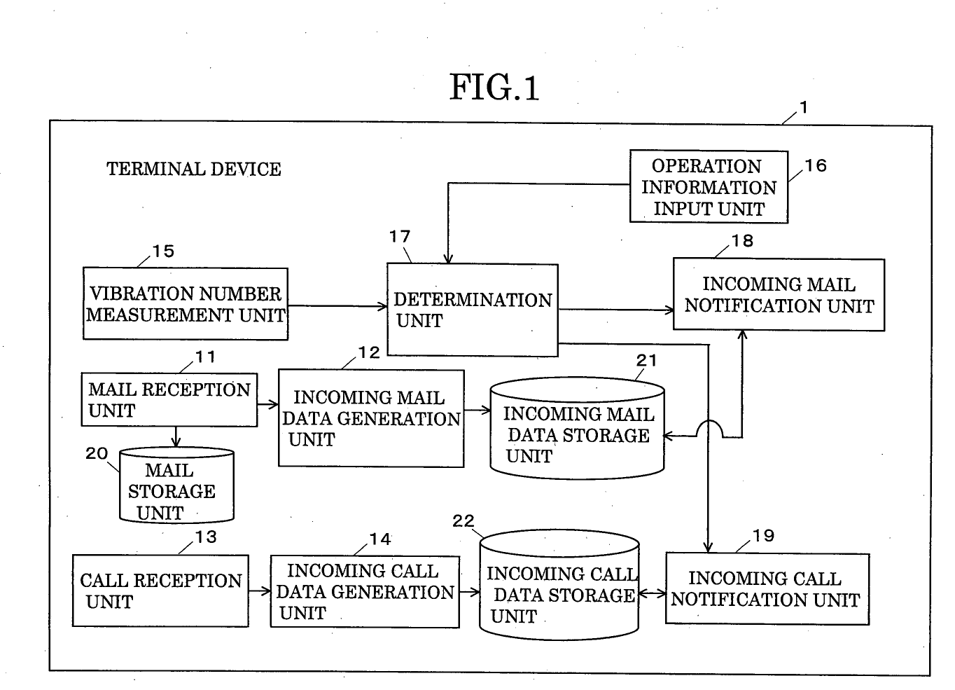

FIG. 1 is a diagram showing an example of a structure of a terminal device of the present invention. A terminal device 1 includes a telephone such as a cellular phone, for example. In this example, as is generally known, the terminal device 1 includes a normal telephone function and an e-mail transmitting/receiving function. The terminal device 1 may further include other functions such as an Internet connection function. The terminal device 1 may be a landline telephone.

The terminal device 1 includes a mail reception unit 11, an incoming mail data generation unit 12, a call reception unit 13, an incoming call data generation unit 14, a vibration number measurement unit 15, an operation information input unit 16, a determination unit 17, an incoming mail notification unit 18, an incoming call notification unit 19, a mail storage unit 20, an incoming mail data storage unit 21, and an incoming call data storage unit 22.

The mail reception unit 11 receives incoming e-mail (incoming mail) to the terminal device 1. The incoming mail data generation unit 12 generates incoming mail data from data related to the received incoming e-mail and stores the incoming mail data in the incoming mail data storage unit 21. The incoming mail data includes, for example, e-mail address of the sender of the e-mail, name of the sender, and reception date/time of the e-mail.

The call reception unit 13 receives an incoming call to the terminal device 1. The incoming call denotes reception of a call. The incoming call data generation unit 14 generates incoming call data from data related to the received incoming call and stores the incoming call data in the incoming call data storage unit 22. The incoming call data includes, for example, phone number of the caller, name of the caller, and reception date/time of the call.

The vibration number measurement unit 15 measures the number of vibrations applied to the terminal device 1. The vibration number measurement unit 15 is, for example, a pedometer embedded in a cellular phone, as is generally known. For example, the vibration number measurement unit 15 measures the number of vibrations applied to the terminal device 1 by user's walking while the user carrying the terminal device 1 is walking, and adds up the measurement result. Once the user stops walking, vibrations are no longer applied to the terminal device 1 so that the number of vibrations measured by the vibration number measurement unit 15 is not added up.

Additionally, for example, the vibration number measurement unit 15 measures and adds up the number of vibrations applied to the terminal device 1 when the terminal device 1 switches from a stopped state to a moving state. The stopped state is, for example, a state that the terminal device 1 is physically static where no vibration is applied, such as while the terminal device 1 is recharged in a battery charger. The moving state is, for example, a state that the terminal device 1 is physically moved, such as when the terminal device 1 in the battery charger is taken out of the battery charger, or when the user grabs the terminal device 1 in the stopped state and is about to move. In the embodiments of the present invention, the moving state includes, for example, during opening and closing operations of the terminal device 1 if the terminal device 1 is a flip cellular phone.

The operation information input unit 16 inputs operation information of the terminal device 1 according to an instruction of a user of the terminal device 1. The operation information is information related to operations of the terminal device 1 (for example, information related to key operations when the terminal device 1 is a cellular phone).

The determination unit 17 determines whether the user has switched from a walking state to a walking-stopped state based on the measured result of the number of vibrations applied to the terminal device 1 measured by the vibration number measurement unit 15. Specifically, the determination unit 17 monitors the number of vibrations measured by the vibration number measurement unit 15 when the incoming mail notification unit 18 notifies the user of the incoming mail, and then determines whether the number of vibrations changes from an added state to a non-added state within a predetermined time. When the determination unit 17 determines that the number of vibrations has changed from the added state to the non-added state within the predetermined time, the determination unit 17 determines that the user has switched from the walking state to the walking-stopped state. When the determination unit 17 determines that the user has switched from the walking state to the walking-stopped state and the operation information input unit 16 has not inputted operation information (for example, when no key on the terminal device 1 has been operated), the determination unit 17 transmits a control signal to the incoming mail notification unit 18 to cause the incoming mail notification unit 18 to re-notify the user of the incoming mail.

Additionally, the determination unit 17 monitors the number of vibrations measured by the vibration number measurement unit 15 when the incoming call notification unit 19 notifies the user of the incoming call, and then determines whether the number of vibrations changes from an added state to a non-added state within a predetermined time. When the determination unit 17 determines that the number of vibrations has changed from the added state to the non-added state within the predetermined time, the determination unit 17 determines that the user has switched from the walking state to the walking-stopped state. When the determination unit 17 determines that the user has switched from a walking state to a walking-stopped state and the operation information input unit 16 has not inputted operation information (for example, when no key on the terminal device 1 has been operated), the determination unit 17 transmits a control signal to the incoming call notification unit 19 to cause incoming call notification unit 19 to re-notify the user of the incoming call.

Furthermore, the determination unit 17 monitors the number of vibrations measured by the vibration number measurement unit 15 when the incoming mail notification unit 18 notifies the user of the incoming mail, and then determines whether the number of vibrations changes from the non-added state to the added state within a predetermined time. When the determination unit 17 determines that the number of vibrations has changed from the non-added state to the added state within the predetermined time, the determination unit 17 determines that the terminal device 1 has switched from the stopped state to the moving state. When the determination unit 17 determines that the terminal device 1 has switched from the stopped state to the moving state and the operation information input unit 16 has not inputted operation information (for example, when no key on the terminal device 1 has been operated), the determination unit 17 transmits a control signal to the incoming mail notification unit 18 to cause the incoming mail notification unit 18 to re-notify the user of the incoming mail.

Additionally, the determination unit 17 monitors the number of vibrations measured by the vibration number measurement unit 15 when the incoming call notification unit 19 notifies the user of the incoming call, and then determines whether the number of vibrations changes from the non-added state to the added state within a predetermined time. When the determination unit 17 determines that the number of vibrations has changed from the non-added state to the added state within the predetermined time, the determination unit 17 determines that the terminal device 1 has switched from the stopped state to the moving state. When the determination unit 17 determines that the terminal device 1 has switched from the stopped state to the moving state and the operation information input unit 16 has not inputted operation information (for example, when no key on the terminal device 1 has been operated), the determination unit 17 transmits a control signal to the incoming call notification unit 19 to cause the incoming call notification unit 19 to re-notify the user of the incoming call.

The incoming mail notification unit 18 notifies the user of the incoming mail when the mail reception unit 11 receives the incoming mail. For example, the incoming mail notification unit 18 notifies the user of the incoming mail by outputting a sound, vibrating, displaying on the screen to notify the incoming mail and so on.

Additionally, the incoming mail notification unit 18 re-notifies the user of the incoming mail based on the control signal received from the determination unit 17. For example, the incoming mail notification unit 18 may re-notify the user of the incoming mail by outputting a sound or by vibrating, or may re-notify the user of the incoming mail by displaying, on the screen of the terminal device 1, the incoming mail data stored in the incoming mail data storage unit 21.

The incoming call notification unit 19 notifies the user of the incoming call when the call reception unit 13 receives the incoming call. For example, the incoming call notification unit 19 notifies the user of the incoming call by outputting a sound, vibrating, displaying on the screen to indicate the incoming call and so on.

Additionally, the incoming call notification unit 19 re-notifies the user of the incoming call based on the control signal received from the determination unit 17. For example, the incoming call notification unit 19 may re-notify the user of the incoming call by outputting a sound or by vibrating, or may re-notify the user of the incoming call by displaying, on the screen of the terminal device 1, the incoming call data stored in the incoming call data storage unit 22.

The e-mail that the mail reception unit 11 has received is stored in the mail storage unit 20. The incoming mail data is stored in the incoming mail data storage unit 21. The incoming call data is stored in the incoming call data storage unit 22.

The terminal device 1 of the present invention is realized by a CPU and a program executed therein. The program that realizes the present invention can be stored in a computer-readable storage medium such as a semiconductor memory, a hard disk, a CD-ROM, and a DVD. The program is provided recorded in these recording media, or provided by transmission and reception through a network via a communication interface.

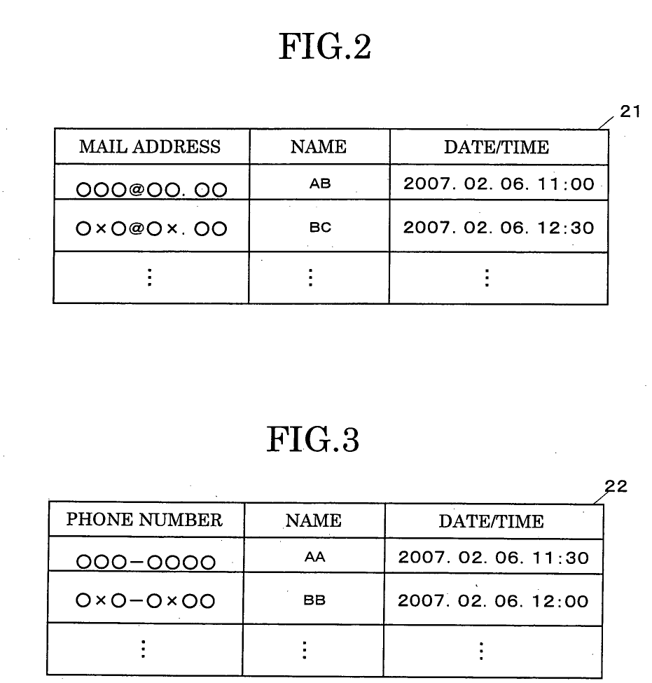

FIG. 2 is a diagram showing an example of the incoming mail data stored in the incoming mail data storage unit. The incoming mail data includes items such as mail address, name, and date/time. The mail address denotes the e-mail address of the sender of the incoming e-mail. The name denotes the name of the sender. The date/time denotes the date/time of the reception of the e-mail.

FIG. 3 is a diagram showing an example of the incoming call data stored in the incoming call data storage unit. The incoming call data includes items such as phone number, name, and date/time. The phone number denotes the phone number of the sender of the incoming call. The name denotes the name of the sender. The date/time denotes the date/time of the reception of the call.

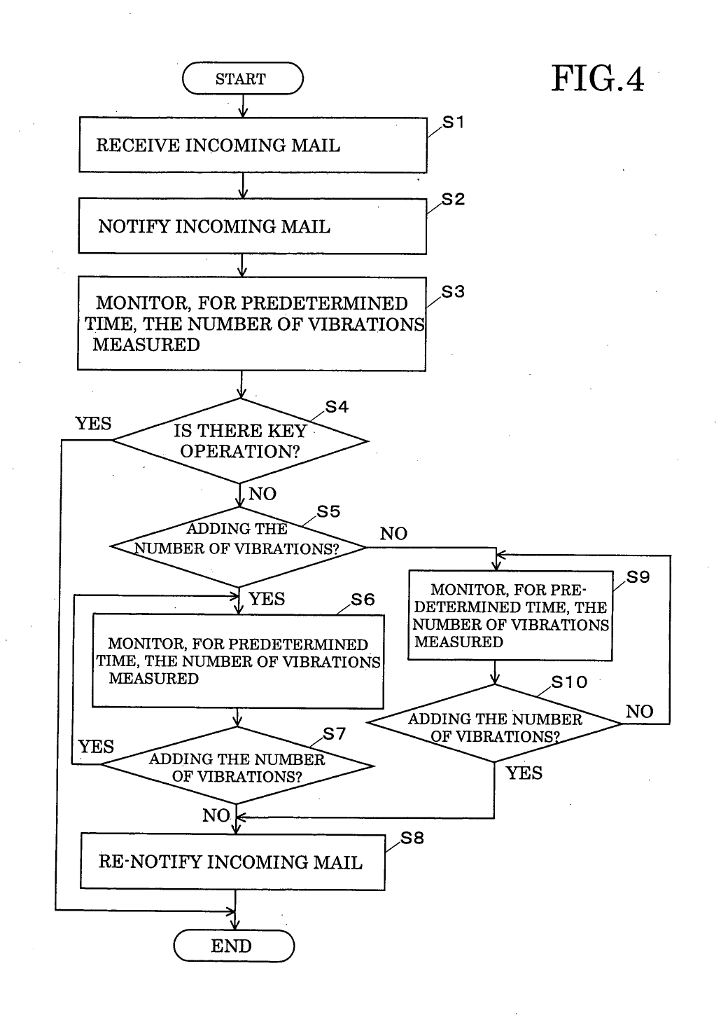

FIG. 4 is a diagram showing an example of an incoming mail notification processing flow of the terminal device of the present invention. First, the mail reception unit 11 of the terminal device 1 receives incoming mail at step S1. The incoming mail notification unit 18 notifies the user of the incoming mail at step S2. The determination unit 17 then monitors, for a predetermined time (for example, 10 seconds), the number of vibrations measured by the vibration number measurement unit 15 at step S3.

The determination unit 17 determines whether a key on the terminal device 1 has been operated at step S4. When the determination unit 17 determines that the key on the terminal device 1 has been operated, the process ends. When the determination unit 17 determines that the key on the terminal device 1 has not been operated, the determination unit 17 determines whether the vibration number measurement unit 15 is adding the number of vibrations at step S5. When the determination unit 17 determines that the vibration number measurement unit 15 is adding the number of vibrations, the determination unit 17 monitors, for a predetermined time (for example, 10 seconds), the number of vibrations measured by the vibration number measurement unit 15 at step S6.

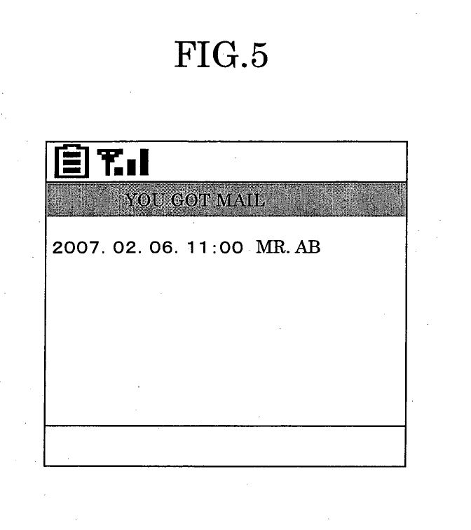

The determination unit 17 determines whether the vibration number measurement unit 15 is adding the number of vibrations at step S7. When the determination unit 17 determines that the vibration number measurement unit 15 is adding the number of vibrations, the process returns to the step S6. When the determination unit 17 determines that the vibration number measurement unit 15 is not adding the number of vibrations (addition of the number of vibrations has stopped), the incoming mail notification unit 18 re-notifies the user of the incoming mail at step S8. In other words, at the step S8, the determination unit 17 recognizes that the addition of the number of vibrations has stopped, determines that the user has switched from a walking state to a walking-stopped state, and then transmits a control signal to the incoming mail notification unit 18 to cause the incoming mail notification unit 18 to re-notify the user of the incoming mail. The incoming mail notification unit 18 notifies the user of the incoming mail by outputting a sound, vibrating, displaying on the screen to notify the incoming mail and so on. For example, the incoming mail notification unit 18 may refer to the incoming mail data shown in the FIG. 2 to display a screen to notify that e-mail transmitted from AB has arrived, as shown in FIG. 5.

At the step S5, when the determination unit 17 determines that the vibration number measurement unit 15 is not adding the number of vibrations, the determination unit 17 monitors, for a predetermined time (for example, 10 seconds), the number of vibrations measured by the vibration number measurement unit 15 at step S9. The determination unit 17 determines whether the vibration number measurement unit 15 is adding the number of vibrations at step S10. When the determination unit 17 determines that the vibration number measurement unit 15 is not adding the number of vibrations, the process returns to the step S9. When the determination unit 17 determines that the vibration number measurement unit 15 is adding the number of vibrations (addition of the number of vibrations has started), the process proceeds to the step S8. In other words, at the step S10, the determination unit 17 recognizes that the addition of the number of vibrations has started, determines that the terminal device 1 has switched from a stopped state to a moving state, and then transmits a control signal to the incoming mail notification unit 18 to cause the incoming mail notification unit 18 to re-notify the user of the incoming mail.

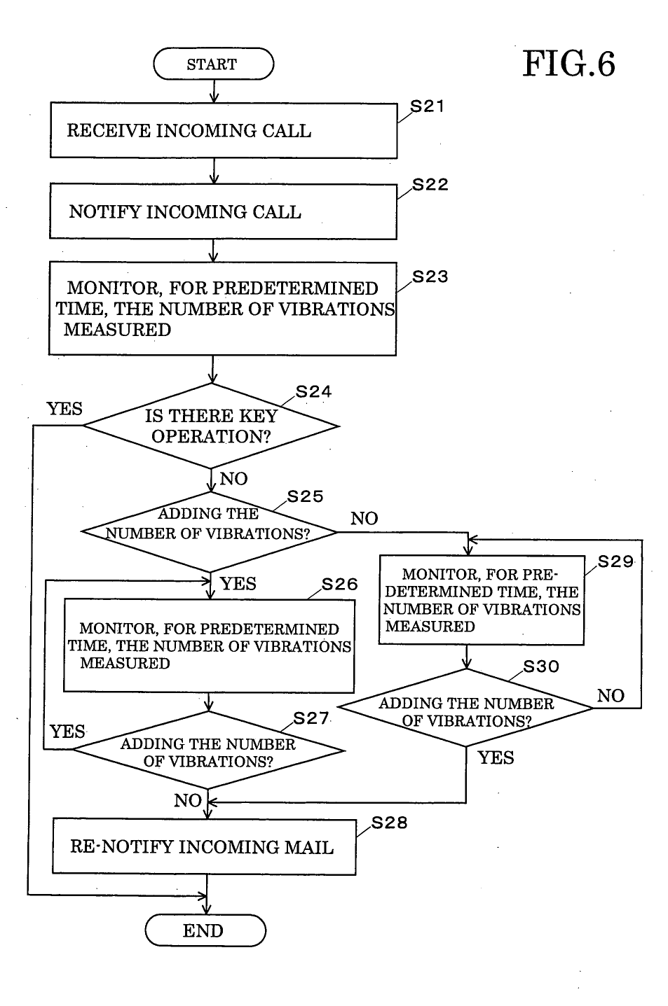

FIG. 6 is a diagram showing an example of an incoming call notification processing flow of the terminal device of the present invention. First, the call reception unit 13 of the terminal device 1 receives an incoming call at step S21. The incoming call notification unit 19 notifies the user of the incoming call at step S22. The determination unit 17 then monitors, for a predetermined time (for example, 10 seconds), the number of vibrations measured by the vibration number measurement unit 15 at step S23.

The determination unit 17 determines whether a key on the terminal device 1 has been operated at step S24. When the determination unit 17 determines that the key on the terminal device 1 has been operated, the process ends. When the determination unit 17 determines that the key on the terminal device 1 has not been operated, the determination unit 17 determines whether the vibration number measurement unit 15 is adding the number of vibrations at step S25. When the determination unit 17 determines that the vibration number measurement unit 15 is adding the number of vibrations, the determination unit 17 monitors, for a predetermined time (for example, 10 seconds), the number of vibrations measured by the vibration number measurement unit 15 at step S26.

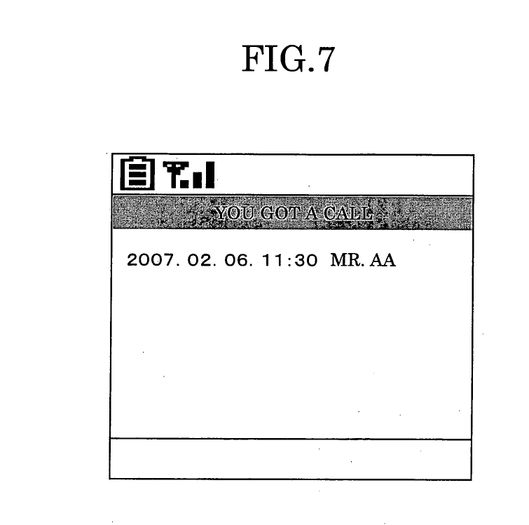

The determination unit 17 determines whether the vibration number measurement unit 15 is adding the number of vibrations at step S27. When the determination unit 17 determines that the vibration number measurement unit 15 is adding the number of vibrations, the process returns to the step S26. When the determination unit 17 determines that the vibration number measurement unit 15 is not adding the number of vibrations (addition of the number of vibrations has stopped), the incoming call notification unit 19 re-notifies the user of the incoming call at step S28. In other words, at the step S28, the determination unit 17 recognizes that the addition of the number of vibrations has stopped, determines that the user has switched from a walking state to a walking-stopped state, and then transmits a control signal to the incoming call notification unit 19 to cause the incoming call notification unit 19 to re-notify the user of the incoming call. The incoming call notification unit 19 notifies the user of the incoming call by outputting a sound, vibrating, displaying on the screen to notify the incoming call and so on. For example, the incoming call notification unit 19 may refer to the incoming call data shown in the FIG. 3 to display a screen to notify that a call from AA has been received, as shown in FIG. 7.

At the step S25, when the determination unit 17 determines that the vibration number measurement unit 15 is not adding the number of vibrations, the determination unit 17 monitors, for a predetermined time (for example, 10 seconds), the number of vibrations measured by the vibration number measurement unit 15 at step S29. The determination unit 17 determines whether the vibration number measurement unit 15 is adding the number of vibrations at step S30. When the determination unit 17 determines that the vibration number measurement unit 15 is not adding the number of vibrations, the process returns to the step S29. When the determination unit 17 determines that the vibration number measurement unit 15 is adding the number of vibrations (addition of the number of vibrations has started), the process proceeds to the step S28. In other words, at the step S30, the determination unit 17 recognizes that the addition of the number of vibrations has started, determines that the terminal device 1 has switched from a stopped state to a moving state, and then transmits a control signal to the incoming call notification unit 19 to cause the incoming call notification unit 19 to re-notify the user of the incoming call.

As described above, according to the present invention, a user, who did not notice the incoming e-mail while walking, is able to confirm the incoming mail when the user stops walking.

Additionally, according to the present invention, for example, a user, who did not notice the incoming mail when the terminal device was left untouched such as during recharging, is able to confirm the incoming mail when the user grabs the terminal device and is about to move.

Additionally, according to the present invention, a user, who did not notice the incoming call while walking, is able to confirm the incoming call when the user stops walking.

Additionally, according to the present invention, for example, a user, who did not notice the incoming call when the terminal device was left untouched such as during recharging, is able to confirm the incoming call when the user grabs the terminal device and is about to move.

What is claimed is:

1. A terminal device comprising:
a mail reception unit for receiving incoming e-mail to the terminal device;
an incoming mail notification unit for notifying a user, of the terminal device, of the incoming e-mail when the incoming e-mail is received;
a vibration number measurement unit for measuring the number of vibrations applied to the terminal device; and
a determination unit for determining whether the user has switched from a walking state to a walking-stopped state based on the number of vibrations measured by the vibration number measurement unit,
wherein the incoming mail notification unit re-notifies the user of the incoming e-mail when the determination unit determines that the user has switched from the walking state to the walking-stopped state.

2. The terminal device according to claim 1,
wherein the determination unit determines whether the terminal device has switched from a stopped state to a moving state based on the number of vibrations measured by the vibration number measurement unit, and
wherein the incoming mail notification unit re-notifies the user of the incoming e-mail when the determination unit determines that the terminal device has switched from the stopped state to the moving state.

3. The terminal device of claim 1, further comprising:
a call reception unit for receiving an incoming call to the terminal device; and
an incoming call notification unit for notifying the user of the incoming call when the call reception unit receives the incoming call,
wherein the incoming call notification unit re-notifies the user of the incoming call when the determination unit determines that the user has switched from the walking state to the walking-stopped state.

4. The terminal device according to claim 3,
wherein the determination unit determines whether the terminal device has switched from a stopped state to a moving state based on the number of vibrations measured by the vibration number measurement unit, and
wherein the incoming call notification unit re-notifies the user of the incoming call when the determination unit determines that the terminal device has switched from the stopped state to the moving state.

5. An incoming e-mail/call notification method in a terminal device, comprising:
receiving incoming e-mail to the terminal device;
notifying a user, of the terminal device, of the incoming e-mail when the incoming e-mail is received;
measuring the number of vibrations applied to the terminal device;
determining whether the user has switched from a walking state to a walking-stopped state based on the measured number of vibrations; and
re-notifying the user of the incoming e-mail when the user is determined to have been switched from the walking state to the walking-stopped state.

6. The incoming e-mail/call notification method according to claim 5, further comprising:
determining whether the terminal device has switched from a stopped state to a moving state based on the measured number of vibrations; and
re-notifying the user of the incoming e-mail when the terminal device is determined to have been switched from the stopped state to the moving state.

7. The incoming e-mail/call notification method according to claim 5, further comprising:
receiving an incoming call to the terminal device;
notifying the user of the incoming call when the incoming call is received; and
re-notifying the user of the incoming call when the user is determined to have been switched from the walking state to the walking-stopped state.

8. The incoming e-mail/call notification method according to claim 7, further comprising:
determining whether the terminal device has switched from the stopped state to the moving state based on the measured number of vibrations; and
re-notifying the user of the incoming call when the terminal device is determined to have been switched from the stopped state to the moving state.
